(19) United States
(12) Patent Application Publication
(10) Pub. No.: US 2006/0048675 A1
(43) Pub. Date: Mar. 9, 2006

(54) Use of preparations comprising pigments and dyestuffs for the decorative colouring of derived timber products

(75) Inventors: Juliane Krusemann, Ludwigshafen (DE); Manfred Siegler, Frankenthal (DE); Andreas Stohr, Freinsheim (DE); Walter Kurtz, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/529,862

(22) PCT Filed: Oct. 6, 2003
(86) PCT No.: PCT/EP03/11016

§ 371 Date: Apr. 1, 2005

(30) Foreign Application Priority Data
Oct. 10, 2002 (DE) 102 47 239.4

(51) Int. Cl. C04B 14/00

(52) U.S. Cl. 106/401

(57) ABSTRACT

The invention relates to the use of liquid colouring preparations, containing at least one pigment and 0.5 to 10 wt. % of at least one dye, based on the pigment, for the decorative colouring of derived timber products.

The present invention relates to the use of liquid colorant preparations which at least one pigment and, based on the weight of the pigment, from 0.5% to 10% by weight of at least one dye for decorative coloration of woodbase materials.

The present invention further relates to woodbase materials which have been colored with these colorant preparations.

In the woodbase materials sector it is in particular the market for medium density fiberboard (MDF) and high density fiberboard (HDF) which has grown strongly.

MDF and HDF can be processed in the same way as conventional chipboard. But by virtue of their uniform construction they are also suitable for producing profiled parts and are therefore becoming increasingly established in furniture making. For example, fittings for rooms and for decorative purposes (eg in exhibition stand construction) and also already high-quality furniture are fabricated from these boards and subsequently only have to be given a colorless coating or overlay in order that the woodlike structure may remain visible.

Hitherto, chipboard and MDF has customarily been colored with dyes which are either added to the binder or applied separately from the binder to the chips/fibers before or after resination, in the course of the board production process. The binders used are amino resins, such as urea- or urea-melamine-formaldehyde resins, but also isocyanates, such as diphenylmethane 4,4′-diisocyanate (MDI), alone or combined with amino resins. For instance, EP-A-903 208 describes the mass coloration of MDF with cationic or direct dyes. True, the fiberboard colored with these dyes has brilliant hues, but only a low lightfastness, which is why it is not very suitable for manufacturing durable articles, such as furniture for the residential sector.

When pigments are used for mass coloration of fiberboard, the colorations, it is true, are faster to light and heat, but they do not exhibit the desired brilliance. For instance, the use of carbon black formulations does not provide dark, brilliant black, but only a dirty gray. Nor does a blue pigment formulation provide a brilliant blue, instead only a greenish blue is obtained, since the intrinsic yellowish brown color of wood causes the blue hue to shift toward a green hue.

WO-A-01/24983 proposes a specific process for coloring wood with pigments. First the wood is treated with soluble pigment precursors in the presence of small amounts of a weakly basic salt and then of an organic acid and the soluble pigment precursors are subsequently converted thermally into the corresponding pigments. However, this process is very costly and inconvenient, since it requires multiple steps and also a separate production of pigment precursors.

EP-A-49 777 describes liquid colorant preparations which contain both pigment and dye for a whole series of applications including the coloration of glues for chipboard. The explicitly disclosed colorant preparations mostly contain an excess of dye, but at least 30% by weight of dye, based on the pigment.

It is an object of the present invention to provide colorant formulations for coloring woodbase materials that provide colorations having advantageous performance properties, especially high brilliance, lightfastness and heatfastness.

We have found that this object is achieved by the use of liquid colorant preparations which contain at least one pigment and, based on the pigment, from 0.5% to 10% by weight of at least one dye, for decorative coloration of woodbase matereials.

These colorant preparations when used for coloring woodbase materials provide strong, brilliant hues, since the dye, owing to its affinity for wood fiber, goes onto the wood fiber and thereby hides the wood's intrinsic color. As a result, the color due to the pigments is shown to full advantage. Surprisingly, the low dye quantities according to this invention are sufficient to obtain a homogeneous strong coloration. Moreover, the coloration obtained with this pigment-dye preparation is distinctly superior to the dye-only coloration with regard to lightfastness, so that the colorant preparations to be used according to this invention can be used for decorative coloration of woodbase materials.

Preferably, the colorant preparations to be used according to this invention contain (A) at least one pigment, (B) at least one dye, (C) at least one dispersant and (D) water or a mixture of water and at least one water retainer.

Component (A) in the colorant preparations to be used according to this invention may be organic or inorganic pigments. It will be appreciated that the colorant preparations may also include mixtures of various organic or various inorganic pigments or mixtures of organic and inorganic pigments.

The pigments are preferably present in finely divided form. Accordingly, the pigments typically have average particle sizes from 0.1 to 5 μm, especially from 0.1 to 3 μm and in particular from 0.1 to 1 μm.

The organic pigments are typically organic chromatic and black pigments. Inorganic pigments can likewise be color pigments (chromatic, black and white pigments) and also luster pigments.

There now follow examples of suitable organic color pigments:

monoazo pigments:
C.I. Pigment Brown 25;
C.I. Pigment Orange 5, 13, 36, 38, 64 and 67;
C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251;
C.I. Pigment Yellow 1, 3, 62, 65, 73, 74, 97, 120, 151, 154, 168, 181, 183 and 191;
C.I. Pigment Violet 32;

disazo pigments:
C.I. Pigment Orange 16, 34, 44 and 72;
C.I. Pigment Yellow 12, 13, 14, 16, 17, 81, 83, 106, 113, 126, 127, 155, 174, 176, 180 and 188;

disazo condensation pigments:
C.I. Pigment Yellow 93, 95 and 128;
C.I. Pigment Red 144, 166, 214, 220, 221, 242 and 262;
C.I. Pigment Brown 23 and 41;

anthanthrone pigments:
C.I. Pigment Red 168;

anthraquinone pigments:
C.I. Pigment Yellow 147, 177 and 199;
C.I. Pigment Violet 31;

anthrapyrimidine pigments:
C.I. Pigment Yellow 108;

quinacridone pigments:
C.I. Pigment Orange 48 and 49;
C.I. Pigment Red 122, 202, 206 and 209;
C.I. Pigment Violet 19;

quinophthalone pigments:
C.I. Pigment Yellow 138;

diketopyrrblopyrrole pigments:
C.I. Pigment Orange 71, 73 and 81;
C.I. Pigment Red 254, 255, 264, 270 and 272;

dioxazine pigments:
C.I. Pigment Violet 23 and 37;
C.I. Pigment Blue 80;

flavanthrone pigments:
C.I. Pigment Yellow 24;

indanthrone pigments:
C.I. Pigment Blue 60 and 64;

isoindoline pigments:
C.I. Pigments Orange 61 and 69;
C.I. Pigment Red 260;
C.I. Pigment Yellow 139 and 185;

isoindolinone pigments:
C.I. Pigment Yellow 109, 110 and 173;

isoviolanthrone pigments:
C.I. Pigment Violet 31;

metal complex pigments:
C.I. Pigment Red 257;
C.I. Pigment Yellow 117, 129, 150, 153 and 177;
C.I. Pigment Green 8;

perinone pigments:
C.I. Pigment Orange 43;
C.I. Pigment Red 194;

perylene pigments:
C.I. Pigment Black 31 and 32;
C.I. Pigment Red 123, 149, 178, 179, 190 and 224;
C.I. Pigment Violet 29;

phthalocyanine pigments:
C.I. Pigment Blue 15, 15:1, 15:2, 15:3, 15:4, 15:6 and 16;
C.I. Pigment Green 7 and 36;

pyranthrone pigments:
C.I. Pigment Orange 51;
C.I. Pigment Red 216;

pyrazoloquinazolone pigments:
C.I. Pigment Orange 67;
C.I. Pigment Red 251;

thioindigo pigments:
C.I. Pigment Red 88 and 181;
C.I. Pigment Violet 38;

triarylcarbonium pigments:
C.I. Pigment Blue 1, 61 and 62;
C.I. Pigment Green 1;
C.I. Pigment Red 81, 81:1 and 169;
C.I. Pigment Violet 1, 2, 3 and 27;

C.I. Pigment Black 1 (aniline black);

C.I. Pigment Yellow 101 (aldazine yellow);

C.I. Pigment Brown 22.

Examples of suitable inorganic color pigments are:

white pigments:
titanium dioxide (C.I. Pigment White 6), zinc white, pigment grade zinc oxide; zinc sulfide, lithopone;

black pigments:
iron oxide black (C.I. Pigment Black 11), iron manganese black, spinel black (C.I. Pigment Black 27); carbon black (C.I. Pigment Black 7);

chromatic pigments:
chromium oxide, chromium oxide hydrate green; chrome green (C.I. Pigment Green 48); cobalt green (C.I. Pigment Green 50); ultramarine green;
cobalt blue (C.I. Pigment Blue 28 and 36; C.I. Pigment Blue 72); ultramarine blue; manganese blue;
ultramarine violet; cobalt violet and manganese violet;
red iron oxide (C.I. Pigment Red 101); cadmium sulfoselenide (C.I. Pigment Red 108); cerium sulfide (C.I. Pigment Red 265); molybdate red (C.I. Pigment Red 104); ultramarine red;
brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange;
cerium sulfide (C.I. Pigment Orange 75);
yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).

Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

The amount of pigment (A) included in the colorant preparations to be used according to this invention is generally in the range from 10% to 70% by weight and preferably in the range from 10% to 60% by weight.

Component (B) in the colorant preparations to be used according to this invention is at least one dye. Dyes which are suitable are in particular dyes which are soluble in water or in a water-miscible or water-soluble organic solvent. Preferably, the dyes (B) used have in each case a hue which is comparable to the pigments (A), since this is a way of achieving a particularly intensive coloration of the woodbase materials. However, it is also possible to use dyes (B) which differ in hue, thereby enabling the coloration to be shaded.

Suitable dyes are in particular cationic and anionic dyes, of which cationic dyes are preferred.

Suitable cationic dyes (B) belong in particular to the di- and triarylmethane, xanthene, azo, cyanine, azacyanine, methine, acridine, safranine, oxazine, induline, nigrosine and phenazine range, and dyes of the azo, triarylmethane and xanthene range are preferred.

Specific examples which may be recited are: C.I. Basic Yellow 1, 2 and 37; C.I. Basic Orange 2; C.I. Basic Red 1 and 108; C.I. Basic Blue 1, 7 and 26; C.I. Basic Violet 1, 3, 4, 10, 11 and 49; C.I. Basic Green 1 and 4; C.I. Basic Brown 1 and 4.

Cationic dyes (B) may also be colorants containing external basic groups. Suitable examples here are C.I. Basic Blue 15 and 161.

Useful cationic dyes (B) further include the corresponding dyebases used in the presence of solubilizing acidic agents. As examples there may be mentioned: C.I. Solvent Yellow 34; C.I. Solvent Orange 3; C.I. Solvent Red 49; C.I. Solvent Violet 8 and 9; C.I. Solvent Blue 2 and 4; C.I. Solvent Black 7.

Suitable anionic dyes are in particular sulfo-containing compounds from the range of the azo, anthraquinone, metal complex, triarylmethane, xanthene and stilbene range, and dyes of the triarylmethane, azo and metal complex (especially copper, chromium and cobalt complex) range are preferred.

Specific examples which may be mentioned are: C.I. Acid Yellow 3, 19, 36 and 204; C.I. Acid Orange 7, 8 and 142; C.I. Acid Red 52, 88, 351 and 357; C.I. Acid Violet 17 and 90; C.I. Acid Blue 9, 193 and 199; C.I. Acid Black 194; anionic chromium complex dyes such as C.I. Acid Violet 46, 56, 58 and 65; C.I. Acid Yellow 59; C.I. Acid Orange 44, 74 and 92; C.I. Acid Red 195; C.I. Acid Brown 355 and C.I. Acid Black 52; anionic cobalt complex dyes such as C.I. Acid Yellow 119 and 204, C.I. Direct Red 80 and 81.

Preference is given to water-soluble dyes.

As water-solubilizing cations there may be mentioned in particular alkali metal cations, such as Li⁺, Na⁺, K⁺, ammonium and substituted ammonium ions, especially alkanolammonium ions.

The amount in which dye (B) is included in the colorant preparations to be used according to this invention is generally in the range from 0.5% to 10% by weight and preferably in the range from 1% to 8% by weight, each percentage being based on the pigment (A). Based on the total weight of the preparation, this corresponds to amounts of generally from 0.05% to 7% by weight and in particular from 0.1% to 5.6% by weight.

Preferred pigment-dye combinations are for example: C.I. Pigment Pigment Blue 15:1 and C.I. Basic Violet 4; C.I. Pigment Green 7 and C.I. Basic Green 4; C.I. Pigment Red 48:2 and C.I. Direct Red 80; C.I. Pigment Black 7 and C.I. Basic Violet 3.

Component (C) in the colorant preparations to be used according to this invention is at least one dispersant.

Particularly suitable dispersants (C) are nonionic and anionic surface-active additives and also mixtures thereof.

Preferred nonionic surface-active additives (C) are based on polyethers in particular.

As well as unmixed polyalkylene oxides, preferably C₂-C₄-alkylene oxides and phenyl-substituted C₂-C₄-alkylene oxides, especially polyethylene oxides, polypropylene oxides and poly(phenylethylene oxide)s, it is in particular block copolymers, especially polymers which contain polypropylene oxide and polyethylene oxide blocks or poly(phenylethylene oxide) and polyethylene oxide blocks, and also random copolymers of these alkylene oxides which are suitable.

These polyalkylene oxides are preparable by polyaddition of the alkylene oxides to starter molecules, as to saturated or unsaturated aliphatic and aromatic alcohols, to phenol or naphthol, which may each be substituted by alkyl, especially C₁-C₁₂-alkyl, preferably C₄-C₁₂-alkyl and C₁-C₄-alkyl respectively, to saturated or unsaturated aliphatic and aromatic amines and to saturated or unsaturated aliphatic carboxylic acids and carboxamides. It is customary to use from 1 to 300 mol and preferably from 3 to 150 mol of alkylene oxide per mole of starter molecule.

Suitable aliphatic alcohols contain in general from 6 to 26 carbon atoms and preferably from 8 to 18 carbon atoms and can have an unbranched, branched or cyclic structure. Examples are octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptylundecanol, 2-octyldecanol, 2-nonyltridecanol, 2-decyltetradecanol, oleyl alcohol and 9-octadecenol and also mixtures of these alcohols, such as C₈/C₁₀, C₁₃/C₁₅ and C₁₆/C₁₈ alcohols, and cyclopentanol and cyclohexanol. Of particular interest are the saturated or unsaturated fatty alcohols obtained from natural raw materials by fat hydrolysis and reduction and the synthetic fatty alcohols from the oxo process. The alkylene oxide adducts with these alcohols typically have average molecular weights Mₙ from 200 to 5 000.

Examples of the abovementioned aromatic alcohols include not only unsubstituted phenol and α- and β-naphthol but also hexylphenol, heptylphenol, octylphenol, nonylphenol, isononylphenol, undecylphenol, dodecylphenol, di- and tributylphenol and dinonylphenol.

Suitable aliphatic amines correspond to the abovementioned

aliphatic alcohols. Again of particular importance here are the saturated and unsaturated fatty amines which preferably have from 14 to 20 carbon atoms. Examples of suitable aromatic amines are aniline and its derivatives.

Useful aliphatic carboxylic acids include especially saturated and unsaturated fatty acids which preferably contain from 14 to 20 carbon atoms and fully hydrogenated, partially hydrogenated and unhydrogenated resin acids and also polyfunctional carboxylic acids, for example dicarboxylic acids, such as maleic acid.

Suitable carboxamides are derived from these carboxylic acids.

As well as alkylene oxide adducts with monofunctional amines and alcohols it is alkylene oxide adducts with at least bifunctional amines and alcohols which are of very particular interest. The at least bifunctional amines preferably have from 2 to 5 amine groups and conform in particular to the formula H₂N—(R-NR¹)ₙ—H (R: C₂-C₆-alkylene; R¹: hydrogen or C₁-C₆-alkyl; n: 1-5). Specific examples are: ethylenediamine, diethylenetriamine, triethylenetetramine, tetraethylenepentamine, 1,3-propylene-diamine, dipropylenetriamine, 3-amino-1-ethyleneaminopropane, hexamethylenediamine, dihexamethylenetriamine, 1,6-bis(3-amino-propylamino)hexane and N-methyldipropylenetriamine, of which hexamethylenediamine and diethylenetriamine are more preferable and ethylenediamine is most preferable.

These amines are preferably reacted first with propylene oxide and then with ethylene oxide. The ethylene oxide content of the block copolymers is typically about 10-90% by weight.

The average molecular weights Mₙ of the block copolymers based on polyamines are generally in the range from 1 000 to 40 000 and preferably in the range from 1 500 to 30 000.

The at least bifunctional alcohols preferably have from two to five hydroxyl groups. Examples are C₂-C₆-alkylene glycols and the corresponding di- and polyalkylene glycols, such as ethylene glycol, 1,2-propylene glycol, 1,3-propylene glycol, 1,2-butylene glycol, 1,4-butylene glycol, 1,6-hexylene glycol, dipropylene glycol and polyethylene glycol, glycerol and pentaerythritol, of which ethylene glycol and polyethylene glycol are more preferable and propylene glycol and dipropylene glycol are most preferable.

Particularly preferred alkylene oxide adducts with at least bifunctional alcohols have a central polypropylene oxide block, ie are based on a propylene glycol or polypropylene glycol which is initially reacted with further propylene oxide and then with ethylene oxide. The ethylene oxide content of the block copolymers is typically in the range from 10% to 90% by weight.

The average molecular weights Mₙ of the block copolymers based on polyhydric alcohols are generally in the range from 1 000 to 20 000 and preferably in the range from 1 000 to 15 000.

Such alkylene oxide block copolymers are known and commercially obtainable, for example under the names Tetronic® and Pluronic® (BASF). Anionic surface-active additives (C) are based in particular on sulfonates, sulfates, phosphonates or phosphates.

Examples of suitable sulfonates are aromatic sulfonates, such as p-C₈-C₂₀-alkylbenzenesulfonates, di(C₁-C₈-alkyl)naphthalene-sulfonates and condensation products of naphthalenesulfonic acids with formaldehyde, and aliphatic sulfonates, such as C₁₂-C₁₈-alkanesulfonates, α-sulfo fatty acid C₂-C₈-alkyl esters, sulfosuccinic esters and alkoxy-, acyloxy- and acylaminoalkanesulfonates.

Preference is given to aryl sulfonates, and the di(C₁-C₈-alkyl)-naphthalenesulfonates are particularly preferred. Diisobutyl- and diisopropylnaphthalenesulfonates are very particularly preferred.

Examples of suitable sulfates are C₈-C₂₀-alkyl sulfates.

A further important group of anionic surface-active additives (C) is formed by the sulfonates, sulfates, phosphonates and phosphates of the polyethers mentioned as nonionic additives.

Reaction with phosphoric acid, phosphorus pentoxide and phosphonic acid on the one hand or with sulfuric acid and sulfonic acid on the other converts these into the phosphoric mono- or diesters and phosphonic esters on the one hand and the sulfuric monoesters and sulfonic esters on the other. These acid esters are preferably in the form of water-soluble salts, especially as alkali metal salts, in particular sodium salts, and ammonium salts, but can also be used in the form of the free acids.

Preferred phosphates and phosphonates are derived in particular from alkoxylated and especially ethoxylated fatty and oxo process alcohols, alkylphenols, fatty amines, fatty acids and resin acids, while preferred sulfates and sulfonates are based in particular on alkoxylated and especially ethoxylated fatty alcohols, alkylphenols and amines, including polyfunctional amines.

Such anionic surface-active additives are known and commercially available for example under the names of Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia) and Lutensit® (BASF).

Suitable anionic surface-active additives (C) are further based on water-soluble polymers which contain carboxylate groups. These may be advantageously adapted to the respective application and the respective pigment by adjusting the ratio between polar and apolar moieties.

Monomers used for preparing these additives are in particular ethylenically unsaturated monocarboxylic acids, ethylenically unsaturated dicarboxylic acids and also vinyl derivatives without an acid function.

Examples which may be mentioned of these monomer groups are:
acrylic acid, methacrylic acid and crotonic acid;
maleic acid, maleic anhydride, maleic monoesters, maleic monoamides, reaction products of maleic acid with diamines that may have been oxidized to derivatives containing amine oxide groups, and fumaric acid, of which maleic acid, maleic anhydride and maleic monoamides are preferred;
styrenics, such as styrene, methylstyrene and vinyltoluene; ethylene, propylene, isobutene; vinyl esters of linear or branched monocarboxylic acids, such as vinyl acetate and vinyl propionate; alkyl esters and aryl esters of ethylenically unsaturated monocarboxylic acids, especially acrylic and methacrylic esters, such as methyl, ethyl, propyl, isopropyl, butyl, pentyl, hexyl, 2-ethylhexyl, nonyl, lauryl and hydroxyethyl (meth)acrylates and also phenyl, naphthyl and benzyl (meth)acrylates; dialkyl esters of ethylenically unsaturated dicarboxylic acids, such as dimethyl, diethyl, dipropyl, diisopropyl, dibutyl, dipentyl, dihexyl, di-2-ethylhexyl, dinonyl, dilauryl and di-2-hydroxyethyl maleates and fumarates; vinylpyrrolidone; acrylonitrile and methacrylonitrile, of which styrene is preferred.

As well as homopolymers of these monomers, especially polyacrylic acids, it is in particular copolymers of the monomers mentioned that are useful as an additive (C). The copolymers may be random copolymers, block copolymers and graft copolymers.

Preferably, the carboxyl groups of the polymeric additives (C) are at least partly present in salt form in order that solubility in water may be ensured. Suitable examples are alkali metal salts, such as sodium and potassium salts, and ammonium salts.

The average molecular weight M_{w} of the polymeric additives (C) is typically in the range from 1 000 to 250 000 and the acid number is generally in the range from 40 to 800.

Examples of preferred polymeric additives. (C) are polyacrylic acids and also styrene-acrylic acid, acrylic acid-maleic acid, butadiene-acrylic acid and styrene-maleic acid copolymers, which may each contain acrylic esters and/or maleic esters as additional monomer constituents.

Particularly preferred polymeric additives (C) are polyacrylic acids, which generally have average molecular weights M_{w} in the range from 1 000 to 250 000 and acid numbers of ≧200, and styrene-acrylic acid copolymers, which generally have an average molecular weight M_{w} in the range from 1 000 to 50 000 and acid numbers of ≧50.

Such anionic surface-active additives are likewise known and commercially available, for example under the names of Sokalan® (BASF), Joncryl® (Johnson Polymer), Neoresin® (Avecia) and also Orotan® and Morez® (Rohm & Haas).

The amount of dispersant (C) in the colorant preparations to be used according to this invention is typically in the range from 1% to 50% by weight and especially in the range from 1% to 40% by weight.

Water forms the liquid vehicle for the colorant preparations to be used according to this invention.

The liquid phase of the colorant preparations is preferably a mixture of water and a water retainer. The water retainers used are in particular organic solvents which are high boiling (ie generally have a boiling point >100° C.) and hence have a water-retaining action and are soluble in or miscible with water.

Example of suitable water retainers are polyhydric alcohols, preferably unbranched and branched polyhydric alcohols containing from 2 to 8 and especially from 3 to 6 carbon atoms, such as ethylene glycol, 1,2-propylene glycol, 1,3-propylene glycol, glycerol, erythritol, pentaerythritol, pentitols, such as arabitol, adonitol and xylitol and hexitols such as sorbitol, mannitol and dulcitol. Useful water retainers further include for example di-, tri- and tetraalkylene glycols and their monoalkyl (especially C₁-C₆-alkyl and in particular C₁-C₄-alkyl) ethers. Examples which may be mentioned are di-, tri- and tetraethylene glycol, diethylene glycol monomethyl, monoethyl, monopropyl and monobutyl ethers, triethylene glycol monomethyl, monoethyl, monopropyl and monobutyl ethers, di-, tri- and tetra-1,2- and -1,3-propylene glycol and di-, tri- and tetra-1,2- and -1,3-propylene glycol monomethyl, monoethyl, monopropyl and monobutyl ethers.

The amount of liquid phase (D) present in the colorant preparations to be used according to this invention is generally in the range from 10% to 88.95% by weight and preferably in the range from 10% to 80% by weight. When water is present in a mixture with a water-retaining organic solvent, this solvent will account for a proportion of phase (D) which is generally in the range from 1% to 80% by weight and preferably in the range from 1% to 60% by weight.

The colorant preparations may further contain customary addition agents, such as biocides, defoamers, antisettling agents and Theological modifiers, and their fraction may generally be up to 5% by weight.

The colorant preparations to be used according to this invention are obtainable in various ways. It is preferable first to prepare a pigment dispersion which is then admixed with the dye as a solid or especially in dissolved form.

The colorant preparations are very useful for coloring woodbase materials of any kind. They are particularly interesting for coloring MDF, HDF and chipboard.

The colorant preparations to be used according to this invention may be added to the wood fiber/chip and binder mixture which serves as a basis for MDF, HDF and chipboard, in various ways and at various stages of the manufacturing operation.

When binders based on amino resins, such as urea- and urea-melamine-formaldehyde resins, are used, the colorant preparations may be applied to the wood fiber or chip together with the binder, which is customarily used in the form of a dispersion containing further addition agents, such as hardeners and paraffin dispersions, or separately from the binder before or after resination. When isocyanates (MDI) are used as a binder, the colorant preparations are used separately from the binder. In the case of combination resinations with amino resins and isocyanates, the colorant preparations may be added to the amino resin component, if desired.

Chipboard is produced by applying resin to the previously dried chips in continuous mixers. Commonly, various chip fractions are differently resinated in separate mixers and then formed into mat separately (multilayered board) or conjointly. All the chip fractions may be colored or only the chips for the outer or the inner layers.

In MDF and HDF production, the fibers are resinated in the blowline downstream of the refiner. The resinated fibers then pass through a dryer where they are dried to moisture contents from 7% to 13% by weight. In some cases, the fibers are also first dried and subsequently resinated in specific continuous mixers. A combination of blowline and mixer resination is possible as well.

To fabricate the boards, the resinated chips or fibers are then formed into mats, if desired pre-compressed cold and pressed in heated presses at from 170 to 240° C. to form boards.

The colorant preparations to be used according to this invention provide advantageous mass coloration of woodbase materials. Colorations which are pervasive, homogeneous, brilliant, strong in color and also fast to light and heat are obtained even in the hitherto inaccessible blue region.

Particular effects are obtainable by multicolored coloration of the boards. For example, differently colored fibers may be pressed in a stratified manner. In this way, a layer of color which serves to identify the board (eg green for moisture resistance and red for fire resistance) may be hidden in the interior of the board and covered up to the outside by sur- and sublayers which are colored as desired. Particularly attractive color effects are obtainable by mixing differently colored fibers and subsequent pressing. This is a way of obtaining marbled boards which become unique woodbase materials. These marbled boards may be used for example to produce unique pieces of furniture, promotional goods and toys. Various other materials, for example other wood fibers and wood waste products, such as bark, may additionally be incorporated to produce particular structures and effects.

Furthermore, by coloring with colorant preparations containing electroconductive carbon black it is even possible to produce electroconductive MDF and chipboard, which are each of interest for electroconductive flooring and worktops for example. Moreover, electroconductive board is coatable by electrostatic powder-spraying processes.

### EXAMPLES

1. Production of colorant preparations

The following colorant preparations were used for coloring chip- and fiberboard.

1.1. Green colorant preparation

Mixture composed of 25% by weight of a green pigment preparation prepared by wet grinding of
40% by weight of C.I. Pigment Green 7
8% by weight of a block copolymer based on ethylenediamine/propylene oxide/ethylene oxide and having an ethylene oxide content of 40% by weight and an average molecular weight Mₙ of 6 500
15% by weight of dipropylene glycol
37% by weight of water

in a stirred ball mill, and 7% by weight of a 47% by weight solution of C.I. Basic Green 7 in 48% by weight acetic acid and 68% by weight water.

1.2. Red colorant preparation

Mixture obtained by wet grinding in a stirred ball mill from
26% by weight of C.I. Pigment Red 48:2
5% by weight of C.I. Direct Red 80
24% by weight of a 26% by weight ammoniacal solution of an acrylic acid-styrene copolymer having an acid number of 216 mg KOH/g and an average molecular weight Mₙ of 9 200
5% by weight of dipropylene glycol
40% by weight of water.

1.3. Black colorant preparation

Mixture composed of 94% by weight of a black pigment preparation prepared by wet grinding
40% by weight of C.I. Pigment Black 7
10% by weight of a block copolymer based on ethylenediamine/propylene oxide/ethylene oxide and having an ethylene oxide content of 40% by weight and an average molecular weight Mₙ of 12 000
22% by weight of dipropylene glycol
28% by weight of water

in a stirred ball mill, and 6% by weight of a 10% by weight solution of C.I. Basic Violet 3 in 30% by weight acetic acid.

1.4. Blue colorant preparation

Mixture composed of 90% by weight of a blue pigment preparation prepared by wet grinding
40% by weight of C.I. Pigment Blue 15:1
8% by weight of a block copolymer based on ethylenediamine/propylene oxide/ethylene oxide and having an ethylene oxide content of 40% by weight and an average molecular weight Mₙ of 6 700
10% by weight of dipropylene glycol
42% by weight of water

in a stirred ball mill, and 10% by weight of a 10% by weight solution of C.I. Basic Violet 4 in 30% by weight acetic acid.

1.5. Conductive black colorant preparation

Mixture composed of 98% by weight of a black pigment preparation produced by wet grinding
20% by weight of conductive carbon black
10% by weight of a block copolymer based on ethylenediamine/propylene oxide/ethylene oxide and having an ethylene oxide content of 40% by weight and an average molecular weight Mₙ of 12 000
70% by weight of water.

in a stirred ball mill, and 2% by weight of a 10% by weight solution of C.I. Basic Violet 3 in 30% acetic acid.

2. Production of colored chipboard

Chipboard was produced using, unless otherwise stated, the glue batches recited in tables 1 and 2:

TABLE 1

| | Center layer | Outside layer |
|---|---|---|
| Glue batch for | chips | chips |
| Urea-melamine- | 100.0 parts | 100.0 parts |
| formaldehyde resin, | by weight | by weight |
| 66.5% by weight in water | | |
| Paraffin dispersion, | 5.0 parts | 4.3 parts |
| 60% by weight in water | by weight | by weight |
| Ammonium sulfate solution, | 10.0 parts | 2.0 parts |
| 25% by weight in water | by weight | by weight |
| Colorant preparation | 10.6 parts | 26.7 parts |
| and water | by weight | by weight |
| Resin solids content of | 53% by weight | 50% by weight |
| liquor | | |
| Resin solids/bone-dry chip | 11% by weight | 13% by weight |
| Liquor per 100 kg of | 20.8 kg | 26.0 kg |
| bone-dry chip | | |

TABLE 2

| | Center layer | Outside layer |
|---|---|---|
| Glue batch for | chips | chips |
| Urea-melamine- | 100.0 parts | 100.0 parts |
| formaldehyde resin, | by weight | by weight |
| 66.5% by weight in water | | |
| Paraffin dispersion, | 6.9 parts | 5.0 parts |
| 60% by weight in water | by weight | by weight |
| Ammonium sulfate solution, | 10.0 parts | 2.0 parts |
| 25% by weight in water | by weight | by weight |
| Colorant preparation | 29.6 parts | 24.2 parts |
| # 1.5 | by weight | by weight |
| Water | — | 1.8 parts |
| | | by weight |
| Resin solids content of | 45.4% by | 50% by weight |
| liquor | weight | |
| Resin solids/bone-dry chip | 8% by weight | 11% by weight |
| Liquor per 100 kg of | 17.6 kg | 22.0 kg |
| bone-dry chip | | |

2.1. Production of green chipboard

The glue batch of table 1 was used, with the batch for the center layer chips being admixed with 1.8 parts by weight and the batch for the outside layer chips with 1.5 parts by weight of colorant preparation # 1.1.

After resination, the chips were formed into a three-layered mat, pre-compressed and pressed at 200° C. to form a board.

The chipboard obtained exhibited a homogeneous, brilliant, lightfast green color.

2. Production of green chipboard having an isocyanate-bound center layer

The outside layer chips were resinated similarly to 2.1. The center layer chips were resinated with 3.5% by weight of isocyanate (MDI) which was emulsified in water (weight ratio 1:1) immediately before resination. Separately, the center layer chips were admixed with 0.3% by weight of colorant preparation # 1.1, 0.8% by weight of the paraffin dispersion and 4% by weight of water.

After resination, the chips were formed into a three-layered mat, pre-compressed and pressed at 200° C. to form a board.

The chipboard obtained exhibited a homogeneous, brilliant, lightfast green color.

2.3. Production of red chipboard

The glue batch of table 1 was used, with the batch for the center layer chips being admixed with 1.8 parts by weight and the batch for the outside layer chips with 1.5 parts by weight of colorant preparation # 1.2.

After resination, the chips were formed into a three-layered mat, pre-compressed and pressed at 200° C. to form a board.

The chipboard obtained exhibited a homogeneous, brilliant, lightfast red color.

2.4. Production of blue chipboard

The glue batch of table 1 was used, with the batch for the center layer chips being admixed with 2.4 parts by weight and the batch for the outside layer chips with 2.0 parts by weight of colorant preparation # 1.4.

After resination, the chips were formed into a three-layered mat, pre-compressed and pressed at 200° C. to form a board.

The chipboard obtained exhibited a homogeneous, brilliant, lightfast blue color.

2.5. Production of a black conductive chipboard

The glue batch of table 2 was used.

After resination, the chips were formed into a three-layered mat, pre-compressed and pressed at 200° C. to form a board.

The chipboard obtained exhibited a homogeneous, brilliant, lightfast black color and had a specific volume resistance of 3×10⁵ Ωcm and also a surface resistance of 4×10⁶ Ωcm.

3. Production of colored MDF

MDF was produced using, unless otherwise stated, the glue batches recited in tables 3 and 4:

TABLE 3

| | |
|---|---|
| Urea-melamine-formaldehyde, | 100.0 parts by weight |
| 66.5% in water | |
| Paraffin dispersion, 60% in | 4.0 parts by weight |
| water | |
| Colorant preparation and water | 54.3 parts by weight |
| Resin solids content of liquor | 42% |
| Resin solids/bone-dry fiber | 14% |
| Liquor per 100 kg of bone-dry | 33.3 kg |
| fiber | |

TABLE 4

| | |
|---|---|
| Urea-melamine-formaldehyde, | 100.0 parts by weight |
| 66.5% in water | |
| Paraffin dispersion, 60% in | 4.0 parts by weight |
| water | |
| Colorant preparation # 1.5 | 19.0 parts by weight |
| Water | 35.3 parts by weight |
| Resin solids content of liquor | 42% |
| Resin solids/bone-dry fiber | 14% |
| Liquor per 100 kg of bone-dry | 33.3 kg |
| fiber | |

3.1. Production of black MDF

The size batch from table 3 was admixed with 19.0 parts by weight of colorant preparation # 1.3.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast black color.

3.2. Production of black isocyanate-bound MDF

The fiber was resinated with 3.5% by weight of isocyanate (MDI) which was emulsified in water (weight ratio 1:1) immediately before resination. Separately, the fiber was admixed with 4% by weight of colorant preparation # 1.3 and 0.8% by weight of the paraffin dispersion.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast black color.

3.3. Production of blue MDF

The size batch from table 3 was admixed with 4.7 parts by weight of colorant preparation # 1.4.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast blue color.

3.4. Production of red MDF

The size batch from table 3 was admixed with 4.7 parts by weight of colorant preparation # 1.2.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast red color.

3.5. Production of green MDF

The size batch from table 3 was admixed with 2.4 parts by weight of colorant preparation # 1.1.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast green color.

3.6. Production of marbled blue/black MDF

Fiber resinated and dried similarly to 3.1 and 3.3 was mixed in a paddle mixer in a blue:black weight ratio of 3:1, then formed into a mat, pre-compressed and pressed at 220° C. to form a board.

The MDF obtained exhibited blue/black marbling.

7. Production of stratified blue/black MDF

Blue chips, resinated and dried similarly to 3.3, were formed into a mat and pre-compressed cold. Black fibers, resinated and dried similarly to 3.1, were poured on top in mat form and likewise-pre-compressed. The mats were then pressed at 220° C. to form a board.

The MDF obtained exhibited a homogeneous, brilliant blue color on one side and a homogeneous, brilliant black color on the other.

3.8. Production of marbled blue/black MDF

Fiber resinated and dried similarly to 3.1 and 3.3 was mixed in a paddle mixer in a blue:black weight ratio of 3:1, then formed into a mat, pre-compressed and pressed at 220° C. to form a board.

The MDF obtained exhibited blue/black marbling.

3.9. Production of marbled blue/green/red MDF

Fiber resinated and dried similarly to 3.3, 3.4 and 3.5 was mixed in a paddle mixer in a blue:green:red weight ratio of 1:1:1, then formed into a mat, pre-compressed and pressed at 220° C. to form a board.

The MDF obtained exhibited blue/green/red marbling.

3.10. Production of black conductive MDF

The glue batch of table 4 was used.

The resinated fiber was subsequently dried in a dryer to a moisture content of about 8% by weight, formed into a mat, pre-compressed and pressed at 220° C. to form a board.

The MDF obtained exhibited a homogeneous, brilliant, lightfast black color and had a surface resistance of 1.3×10⁵ Ωcm.

1. A method for decorative coloration of woodbase materials comprising applying a liquid colorant preparation that comprises at least one pigment and, based on the pigment, from 0.5% to 10% by weight of at least one dye to a wood based material.

2. The method of claim 1, wherein the preparation comprises
(A) at least one pigment,
(B) at least one dye,
(C) at least one dispersant,
(D) water or a mixture of water and at least one water retainer, and
(E) optionally further customary constituents for colorant preparations.

3. The method of claim 1, wherein component (B) of the preparation comprises at least one anionic or cationic dye.

4. The use method of claim 1 wherein component (C) of the preparation comprises at least one nonionic surface-active additive, at least one anionic surface-active additive or a mixture thereof.

5. The method of claim 1, wherein the water retainer of the preparation comprises a high-boiling organic solvent which is soluble in or miscible with water.

6. The method of claim 1, wherein the preparation comprises
from 10% to 70% by weight of component (A),
from 0.05% to 7% by weight of component (B),
from 1% to 50% by weight of component (C),
from 10% to 88.95% by weight of component (D), and
from 0% to 5% by weight of further customary constituents for colorant preparations, each percentage being based on the total weight of the preparation.

7. A method for mass coloration of MDF, HDF and chipboard comprising utilizing the method of claim 1.

8. A method for producing colored board which is multicolored in layers or marbled comprising utilizing the method of claim 7.

9. A method for producing electroconductive black board comprising utilizing the method of claim 7.

10. A woodbased material colored with the colorant preparations produced by the method of claim 1.

11. An article produced by the method as claimed in claim 1.

12. The article as claimed in claim 11 wherein said article is MDF, HDF, chipboard, colored Board or electroconductive black board.
